(19) United States
(12) Patent Application Publication
(10) Pub. No.: US 2003/0216157 A1
(43) Pub. Date: Nov. 20, 2003

(54) Wireless communication apparatus with a flat speaker

(75) Inventors: Shih-Chieh Wang, Taipei (TW); Chien-Lung Huang, Taipei (TW); Yen-Te Chiang, Taipei (TW); James Tseng, Shulin City (TW); Chu-Yang Hsu, Hsinchu (TW); Hsi-Hsing Hsu, Luju Shiang (TW)

Correspondence Address: BRUCE H. TROXELL, SUITE 1404, 5205 LEESBURG PIKE, FALLS CHURCH, VA, 22041, US

(73) Assignee: High Tech Computer Corp.

(21) Appl. No.: 10/435,538

(22) Filed: May 12, 2003

(30) Foreign Application Priority Data
May 14, 2002 (TW) 91206862

(51) Int. Cl. H04M 1/00

(52) U.S. Cl. 455/575.1; 455/575.3; 379/433.02; 379/433.04; 379/433.11; 345/169

(57) ABSTRACT

A wireless communication apparatus integrates a flat speaker (33) onto a liquid crystal display (12) or a rotational shield (3) of the apparatus. The flat speaker includes a vibrator (30) and a transparent vibrating membrane (31) which generates sound when the vibrator vibrates. The transparent vibrating membrane is mounted with a predetermined spacing over the liquid crystal display or over an inner surface of the rotational shield so as to gain a broader voicing surface. Thereby, by providing the flat speaker, the wireless communication apparatus can have a better audio effect.

### BACKGROUND OF THE INVENTION

(1) Field of the Invention

The invention relates to a wireless communication apparatus with a flat speaker, and more particularly to the apparatus which integrates a flat or planar speaker onto a liquid crystal display or a shield of the apparatus.

(2) Description of the Prior Art

In the wireless communication industry, products such as mobile phones, personal digital assistants, and the like wireless communication devices with liquid crystal displays are usually tradeoff profiled between the audio effect and the minimization of the configuration in consideration of the limitation upon their body sizes. The topic of this invention is to provide an improvement capable of having a better audio effect and a possibility of minimizing its configuration.

Referring to FIG. 1, a conventional mobile phone is perspective shown. A body 10 of the mobile phone 1 includes a liquid crystal display 12, a touch button assembly 11, and a speaker 15 (or say an earphone). Obviously, in the design of the mobile phone 1, the speaker 15 is usually deemed as an alternative for a receiving end of a conventional handset so that the speaker 15 is usually constructed in an earphone scale. It is easy to see that the convenient hook-up receiving function of the conventional desktop phone is inevitably discarded in the construction of the mobile phone 1.

Referring to FIG. 2, a conventional personal digital assistant with a protection shield is perspective shown. A body 10 of the personal digital assistant 2 includes a liquid crystal display 12, a control button 13, a shield 3, and a speaker 15 (or say an earphone) constructed at a root of the shield 3. As shown, the shield 3 includes a window 4 located respective over the liquid crystal display 12 for providing a see-through function while covering the liquid crystal display 12.

Referring to FIG. 3, a simplified cross-sectional view of the personal digital assistant 2 of FIG. 2 is shown. In FIG. 3, only related components to the present invention are present in order to provide a better understanding about the relationship in between. In the personal digital assistant 2 shown in FIG. 2 and FIG. 3, the liquid crystal display 12 is usually overlapped by a touch screen 17 for cooperating with a stylus (not shown) to form an interactive environment, so that data or instructions can be input into the personal digital assistant 2 by using the stylus.

As previously described, while considering the space limitation of the body 10 of the wireless communication apparatus 1 or 2, the speaker 15 is usually designed to one that presents only a less power, a small audio volume, and a limited audible range. Therefore, the usage of the conventional wireless communication apparatus 1 or 2 is usually treated as a personal equipment. However, a need for the wireless communication apparatus 1 or 2 to have a broadcasting function and a larger audio spectrum is always there, especially in the circumstance that the wireless communication apparatus 1 or 2 is used as a communication interface in a distant video meeting.

Therefore, an improvement of the wireless communication apparatus to enhance the audio effect is definitely worthy and welcome by the skilled in the art.

### SUMMARY OF THE INVENTION

Accordingly, it is a primary object of the present invention to provide a wireless communication apparatus with a flat speaker for broadening a voicing surface and enhancing an audio effect by mounting parallel a flat speaker on a liquid crystal display or a shield of the apparatus.

In an embodiment in accordance with the present invention, the wireless communication apparatus with a flat speaker includes a body and a liquid crystal display mounted on the body. The apparatus is characterized in having a flat speaker mounted on the body in which the flat speaker further includes a vibrator and a transparent vibrating membrane mounted parallel and by a predetermined spacing over the liquid crystal display.

In this embodiment, the wireless communication apparatus can further include a touch screen mounted parallel and by another predetermined spacing over the transparent vibrating membrane.

In another embodiment of the present invention, the wireless communication apparatus with a flat speaker includes a body and a shield mounted on the body by a pivotal mechanism. The shield further has an inner surface facing the body. The apparatus is characterized in having a flat speaker mounted on the shield in which the flat speaker further includes a vibrator and a transparent vibrating membrane mounted parallel and by a predetermined spacing over the inner surface.

In this embodiment, the vibrator can be located inside the pivotal mechanism.

All these objects are achieved by the wireless communication apparatus with a flat (or planar) speaker described below.

### BRIEF DESCRIPTION OF THE DRAWINGS

The present invention will now be specified with reference to its preferred embodiment illustrated in the drawings, in which

FIG. 1 is a perspective view of a conventional mobile phone;

FIG. 2 is a perspective view of a conventional personal digital assistant;

FIG. 3 is a simplified cross-sectional view of FIG. 2;

FIG. 4 is a schematic cross-sectional view of a first embodiment of the wireless communication apparatus with a flat speaker in accordance with the present invention;

FIG. 5 is a schematic cross-sectional view of a second embodiment of the wireless communication apparatus with a flat speaker in accordance with the present invention;

FIG. 6 is a schematic cross-sectional view of a third embodiment of the wireless communication apparatus with a flat speaker in accordance with the present invention; and

FIG. 7 is a perspective view of a fourth embodiment of the wireless communication apparatus with a flat speaker in accordance with the present invention.

### DESCRIPTION OF THE PREFERRED EMBODIMENT

The invention disclosed herein is directed to a wireless communication apparatus with a flat speaker. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the following description, those components having the same function but different profiles or locations are named and labeled by the same so as to achieve consistency in presenting the present invention.

Referring now to FIG. 4, a schematic cross-sectional view of the first embodiment of the wireless communication apparatus with a flat speaker in accordance with the present invention is shown. The wireless communication apparatus includes a body 10, a liquid crystal display 12 mounted on the body 10, and a flat speaker 33 mounted on the body 10. The flat speaker 33 further includes a vibrator 30 mounted on the body 10 and a transparent vibrating membrane 31 mounted parallel and by a predetermined spacing S over the liquid crystal display 12. The vibrating membrane 31 generates sound when the vibrator 30 is powered to vibrate.

In the present invention, the transparent vibrating membrane 31 for generating the vibration for voicing is preferably mounted over the liquid crystal display 12 by a parallel and overlapping pattern so as to achieve a broader voicing surface. While in installation, the transparent vibrating membrane 31 is peripherally fixed (not shown in the figures) and has the vibrator 30 positioned at one side thereof. The vibrator 30, under control of a control unit of the wireless communication system, is used to generate predetermined patterns of vibrations for forming purposely audio effects through the transparent vibrating membrane 31.

In the present invention, the transparent vibrating membrane 31 is freely suspended by the peripherally fixation, so that a sufficient free surface can be provided to form an audio effect with better volume performance (i.e., a bigger range of oscillation amplitude). However, to accommodate the oscillation of the transparent vibrating membrane 31, the predetermined spacing S as shown is required between the transparent vibrating membrane 31 and the liquid crystal display 12.

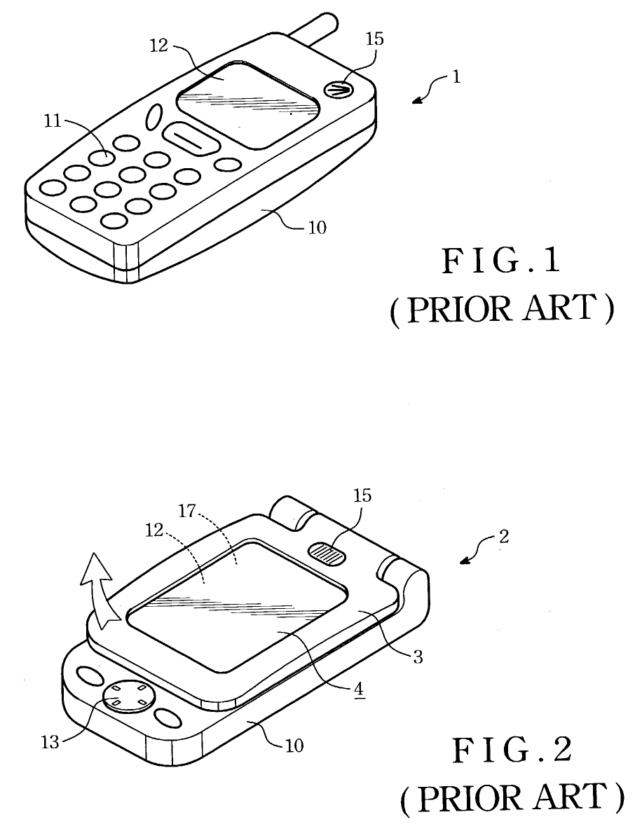

The first embodiment of the present invention as shown in FIG. 4 can be seen as an improvement upon the mobile phone of FIG. 1. By providing the flat speaker 33 (or say, planar speaker), the audio volume can be extended so that the apparatus or the mobile phone can perform easily the hand-free receiving mode. Of course, the apparatus of the present invention can also include the earphone device in the art, like the mobile phone of FIG. 1 does, so that a dual-receiving mode product can be formed. Yet, the combination of both the earphone and the flat speaker into the apparatus can be easily achieved by a person skilled in the art, after understanding previous disclosure of the present invention; so the related description will be omitted herein.

Referring now to FIG. 5, a simplified cross-sectional view of a second embodiment of the present invention is shown. In the second embodiment, the wireless communication apparatus further includes a touch screen 17 for cooperating with a stylus (not shown) to form an interactive environment. It is noted that the touch screen 17 needs to be positioned at the top of the body 10 so as to make possible a direct contact with the stylus. Therefore, as shown in the second embodiment, the transparent vibrating membrane 31 of the flat speaker 33 is located between the touch screen 17 and the liquid crystal display 12. Definitely, spacing at either side of the vibrating membrane 31 is required.

As shown in FIG. 5, it is obvious that the second embodiment is an. improvement upon the personal digital assistant and the like.

Referring now to FIG. 6, a simplified cross-sectional view of a third embodiment of the present invention is shown. In the third embodiment, the wireless communication apparatus further includes a shield 3 for covering the liquid crystal display 12 on the body 10. The flat speaker 33 can be mounted at an inner surface 35 of the shield 3. Also, the central part of the transparent vibrating membrane 31 of the flat speaker 33 is spaced from the inner surface 35 of the shield 3 by a predetermined spacing for avoiding any possibility of voicing interference to the transparent vibrating membrane 31.

As shown, the wireless communication apparatus having a shield can be seen on various products such as mobile phones, personal digital assistants, and the like device. Also, in the apparatus shown in FIG. 6, a touch screen 17 as described above can be constructed over the liquid crystal display 12 of the body 10.

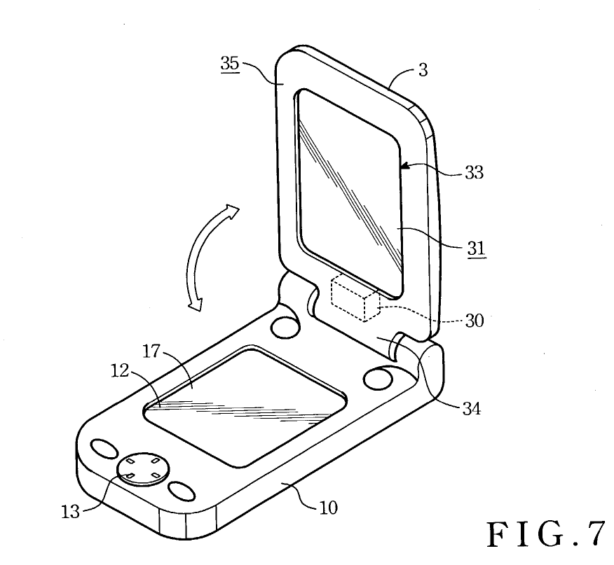

Referring now to FIG. 7, a perspective view of a fourth embodiment of the present invention is shown. In the embodiment, the wireless communication apparatus includes a shield 3 mounted on the body 10 by a pivotal mechanism 34. The shield 3 further has an inner surface 35 facing the body 10. The apparatus as shown is characterized in having a flat speaker 33 mounted on the shield 3 in which the flat speaker 33 further includes a vibrator 30 and a transparent vibrating membrane 31 mounted parallel and by a predetermined spacing over the inner surface 35. As shown, the vibrator 30 of the flat speaker 33 is preferably located inside the pivotal mechanism 34.

As the embodiment shown in FIG. 7, the wireless communication apparatus can obtain a broader voicing surface by constructing the flat speaker 33 onto the shield 3. Thereby, the apparatus of the present invention can easily act as a communication interface at a distant meeting.

In the present invention, circuitry for controlling the vibration of the vibrator 30 can be constructed integrally with the circuitry of the wireless communication system. Yet, the related circuiting is well known in the art, so the description will be omitted herein.

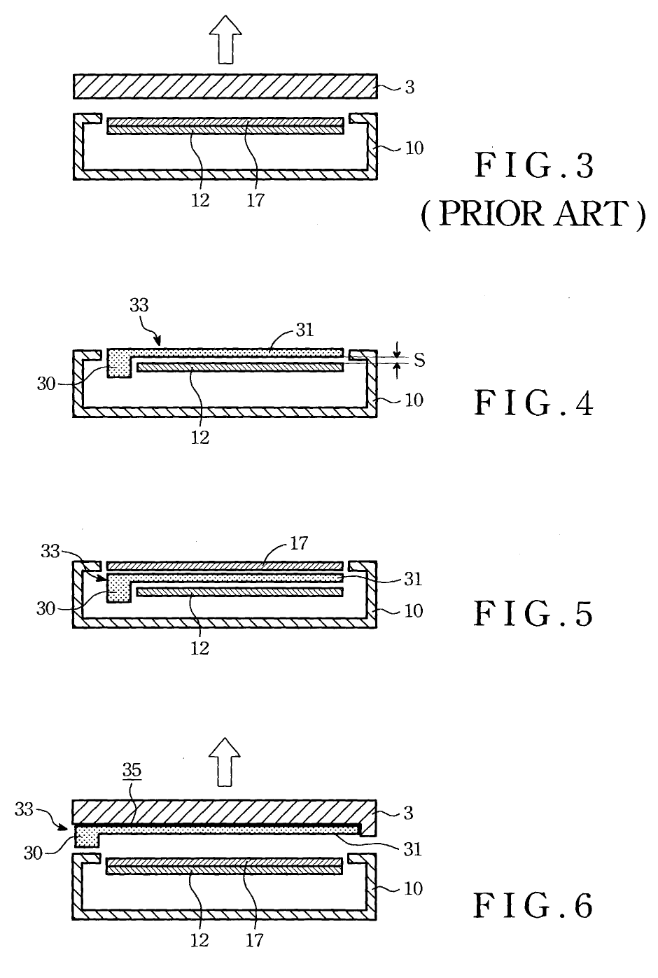

In the FIG. 3 to FIG. 6, only major parts of the wireless communication apparatus are shown by respective simplified cross-sectional views for clearly demonstrating the characteristics of the present invention, and the omitted of the apparatus obviously include circuiting and related connecting parts. Yet, it does definitely not affect the embodying of the present invention for all the features leading to implementation of the present invention have already been disclosed in the above description.

While the present invention has been particularly shown and described with reference to a preferred embodiment, it will be understood by those skilled in the art that various changes in form and detail may be without departing from the spirit and scope of the present invention.

We claim:

1. A wireless communication apparatus with a flat speaker, comprising a body and a liquid crystal display mounted on the body, characterized on that: the apparatus comprises a flat speaker mounted on the body in which the flat speaker includes a vibrator and a transparent vibrating membrane mounted parallel and by a predetermined spacing over the liquid crystal display.

2. The wireless communication apparatus with a flat speaker according to claim 1 further includes thereof a touch screen mounted parallel and by another predetermined spacing over said transparent vibrating membrane.

3. A wireless communication apparatus with a flat speaker, comprising a body and a shield mounted on the body by a pivotal mechanism, the shield further having thereof an inner surface facing the body, characterized on that: the apparatus comprises a flat speaker mounted on the shield in which the flat speaker includes a vibrator and a transparent vibrating membrane mounted parallel and by a predetermined spacing over the inner surface of the shield.

4. The wireless communication apparatus with a flat speaker according to claim 3, wherein said vibrator is located inside said pivotal mechanism.

5. A handheld device, comprising:
a body having a display mounted therein; and
a speaker mounted over the display, comprising
a vibrator;
a transparent vibrating membrane mounted parallel and by a predetermined spacing over the display, the vibrating membrane generating sound when the vibrator vibrates.

6. The handheld device according to claim 5 further comprising a touch panel over the vibrating membrane, the touch panel being adapted for interacting with a stylus.

7. The handheld device according to claim 6 further comprising a shield and wherein the speaker is attached to the shield.

8. The handheld device according to claim 7 further comprising a touch panel adapted for interacting with a stylus, the touch panel being located between the display and the speaker.

9. The handheld device according to claim 6, wherein the shield is connected to the body via a pivotal mechanism, the vibrator being received in the pivotal mechanism.

10. The handheld device according to claim 9 further comprising a touch panel adapted for interacting with a stylus, the touch panel being located between the display and the speaker.
